(19) United States
(12) Patent Application Publication
(10) Pub. No.: US 2024/0320495 A1
(43) Pub. Date: Sep. 26, 2024

(54) INFORMATION PROCESSING METHOD, INFORMATION PROCESSING SYSTEM, AND COMPUTER-READABLE NON-TRANSITORY RECORDING MEDIUM HAVING INFORMATION PROCESSING PROGRAM RECORDED THEREON

(71) Applicant: Panasonic Intellectual Property Management Co., Ltd., Osaka (JP)

(72) Inventors: Satoshi Sato, Kyoto (JP); Kunio Nobori, Osaka (JP); Shunsuke Yasugi, Osaka (JP)

(21) Appl. No.: 18/732,866

(22) Filed: Jun. 4, 2024

Related U.S. Application Data
(63) Continuation of application No. PCT/JP2022/044680, filed on Dec. 5, 2022.

(30) Foreign Application Priority Data
Dec. 9, 2021 (JP) 2021-200097

(51) Int. Cl. G06N 3/084; G03B 19/16

(52) U.S. Cl. CPC G06N 3/084; G03B 19/16

(57) ABSTRACT

A third model training part trains a second neural network model by backpropagation using an error difference between: an identification result which a third neural network model including a trained first neural network model and the second neural network connected to each other outputs after receiving second sensing data and a first operation parameter, and correct identification information corresponding to the second sensing data. A second operation parameter acquisition part acquires a second operation parameter by updating the first operation parameter via the first neural network model by the backpropagation.

### FIELD OF INVENTION

The present disclosure relates to a technology of generating an identification model through machine learning, and optimizing an operation parameter of a sensor to obtain sensing data to be input into an identification model.

### BACKGROUND ART

A technology of identifying an object and recognizing an environment therearound is important for an autonomous vehicle and an autonomous robot. The technology called “Deep Learning” has recently attracted attention for identification or recognition of an object. The deep learning indicates machine learning using a multilayer neural network and achieves, by using a large amount of training data, an identification performance with a higher accuracy than an accuracy of conventional machine learning. Besides, image information is particularly effective in such object identification. For instance, Non-patent Literature 1 discloses a way for significantly improving a conventional object identification performance through deep learning using input image information.

Such an information processing system widely uses a camera serving as an input device for inputting the image information into the system. A commercially available camera is typically adopted for the camera. In this regard, such a commercially available camera has been developed for viewing by a person, and thus is not optimal as an input device for the deep learning or other machine learning. For instance, Non-patent Literature 2 discloses that a chromatic aberration or astigmatism which is unnecessary for a typical camera plays an important role in deep learning to estimate a depth or detect a three-dimensional object. Non-patent Literature 2 further discloses, for example, a way of optimally designing an operation parameter, such as the chromatic aberration or the astigmatism, by formulating image formation by the camera as a differentiable model with use of wave optics for expressing refraction or diffraction, and training this model and a deep learning model to estimate the depth by backpropagation.

Moreover, for instance, Non-patent Literature 3 discloses a way of, in recognition of an action from a time-space compressive sensing image, optimizing a compressive sensing pattern and an identification model to be optimal for recognizing the action by expressing space-time compressive sensing as “Encoding network” through the deep learning.

However, each of the conventional technologies faces difficulties in optimizing an operation parameter of a sensor serving as an input device for the neural network model and improving an identification or recognition accuracy of the neural network model, and thus needs further improvement.

Non-patent Literature 1: A. Krizhevsky, I. Sutskever, and G. E. Hinton, “ImageNet Classification with Deep Convolutional Neural Networks”, NIPS' 12: Proceedings of the 25^{th}International Conference on Neural Information Processing Systems, Volume 1, pp. 1097 to 1105 December 2012.

Non-patent Literature 2: Julie Chang and Gordon Wetzstein, “Deep Optics for Monocular Depth Estimation and 3D Object detection”, Proceedings of the IEEE International Conference on Computer Vision, pp. 10193 to 10202, 2019.

Non-patent Literature 3: Tadashi Okawara, Michitaka Yoshida, Hajime Nagahara, and Yasushi Yagi, “Action Recognition from a Single Coded Image”, Proceedings of the IEEE International Conference on Computational Photography, 2020.

### SUMMARY OF THE INVENTION

The present disclosure has been accomplished to solve the drawbacks described above, and has an object of providing a technology for optimizing an operation parameter of a sensor serving as an input device for a neural network model and improving an identification accuracy of the neural network model.

An information processing method according to the present disclosure includes: by a computer, training a first neural network model so as to receive a first operation parameter for an operation of a first sensor and second sensing data obtained by an operation of a second sensor and output first sensing data obtained by the operation of the first sensor using the first operation parameter; generating a third neural network model including the first neural network model and a second neural network model connected to each other in such a manner that the second neural network model receives the first sensing data output from the trained first neural network model and outputs an identification result of the first sensing data; training the second neural network model by backpropagation using an error difference between: the identification result which the third neural network model outputs after receiving the second sensing data and the first operation parameter; and correct identification information corresponding to the second sensing data; and acquiring a second operation parameter by updating the first operation parameter via the first neural network model by the backpropagation.

This disclosure achieves optimization of an operation parameter of a sensor serving as an input device for a neural network model and improvement in an identification accuracy of the neural network model.

### BRIEF DESCRIPTION OF THE DRAWINGS

FIG. 1 is a block diagram showing a configuration of a training system according to an embodiment of the present disclosure.

FIG. 2 is a schematic view of a structure of a lens-less multi-pinhole camera serving as an example of a first sensor.

FIG. 3 is a flowchart explaining a training process by the training system according to the embodiment of the disclosure.

FIG. 4 is a schematic view explaining training of a first neural network model in the embodiment.

FIG. 5 is a schematic view explaining training of a third neural network model in the embodiment.

FIG. 6 is a schematic view showing an example of a multi-pinhole mask having a plurality of pinholes.

FIG. 7 is a schematic view showing an example of a second sensor that captures images respectively at a plurality of viewpoint positions.

FIG. 8 is a schematic view of a structure of a coded aperture camera serving as another example of the first sensor.

### DETAILED DESCRIPTION

Knowledge forming the basis of the present disclosure

Non-patent Literature 2 mentioned above expresses image formation by a camera with a differentiable model to obtain an optimal chromatic aberration or optimal astigmatism. However, such an input device as expressible with the differentiable model is limited. In practical use, Non-patent Literature 2 adopts approximation with a layered structure obtained by quantizing a depth of a subject or approximation making a blur which differs in fact depending on a location on an image sensor defined to be uniform to express image formation by the camera with a differentiable model. This makes the object detection accuracy of the model inferior to an accuracy of three-dimensional object detection using highly accurate depth information.

Non-patent Literature 3 discloses establishment of a single layer network having an encoded exposure pattern of compressive sensing. However, a more complicated imaging system for image formation by camera faces a difficulty in establishing such a network. Further, use of a device with an unknown model has been avoided.

By contrast, an information processing method using an input device in the present disclosure attains optimization of an operation parameter of an input device by using a regression model which predicts an output of the input device based on the operation parameter of the input device. The regression model is trained through machine learning, such as deep learning. The regression model is differentiable owing to the training through the deep learning, and thus may avoid use of the approximation disclosed Non-patent Literature 2. The regression model is acquired through the training without depending on a form of an input device, and hence is adjustable to a complicated model and an unknown model. This enables designing of an optimal operation parameter without depending on an input device. The following technologies will be described to solve the drawbacks.

(1) An information processing device according to one aspect of the present disclosure includes: by a computer, training a first neural network model so as to receive a first operation parameter for an operation of a first sensor and second sensing data obtained by an operation of a second sensor and output first sensing data obtained by the operation of the first sensor using the first operation parameter; generating a third neural network model including the first neural network model and a second neural network model connected to each other in such a manner that the second neural network model receives the first sensing data output from the trained first neural network model and outputs an identification result of the first sensing data; training the second neural network model by backpropagation using an error difference between: the identification result which the third neural network model outputs after receiving the second sensing data and the first operation parameter; and correct identification information corresponding to the second sensing data; and acquiring a second operation parameter by updating the first operation parameter via the first neural network model by the backpropagation.

In this configuration, the first neural network model is trained so as to receive the first operation parameter for an operation of the first sensor and the second sensing data obtained by an operation of the second sensor and output the first sensing data obtained by the operation of the first sensor using the first operation parameter. Then, the third neural network model is generated to include the first neural network model and the second neural network model connected to each other in such a manner that the second neural network model receives the first sensing data output from the trained first neural network model and outputs an identification result of the first sensing data. The second neural network model is trained by backpropagation using an error difference between: the identification result which the third neural network model outputs after receiving the second sensing data and the first operation parameter; and correct identification information corresponding to the second sensing data. Further, the second operation parameter is acquired by updating the first operation parameter via the first neural network model by the backpropagation. This configuration thus achieves optimization of the operation parameter of the sensor serving as an input device for a neural network model and improvement in an identification accuracy of the neural network model.

(2) In the information processing method according to (1) above, the first sensor may be a coded aperture camera, and the first operation parameter may include at least one of a distance between an encoded mask and an image sensor, the number of pinholes, a size of each of the pinholes, and a position of each of the pinholes.

It is necessary to determine an optimal first operation parameter in consideration of a large change in an image captured by the coded aperture camera due to at least one of the distance between the encoded mask and the image sensor, the number of pinholes, the size of each of the pinholes, and the position of each of the pinholes, each included in the first operation parameter. This configuration optimizes the first operation parameter to improve the identification result from the second neural network model. The optimization leads to improvement in an identification performance of the second neural network model.

(3) In the information processing method according to (1) above, the first sensor may be a lens-less multi-pinhole camera, and the first operation parameter may include at least one of a focal distance of the lens-less multi-pinhole camera, the number of pinholes, a size of each of the pinholes, and a position of each of the pinholes.

It is necessary to determine an optimal first operation parameter in consideration of a large change in an image captured by the lens-less multi-pinhole camera due to at least one of the focal distance of the lens-less multi-pinhole camera, the number of pinholes, the size of each of the pinholes, and the position of each of the pinholes, each included in the first operation parameter. This configuration optimizes the first operation parameter to improve the identification result of from the second neural network model. The optimization leads to improvement in an identification performance of the second neural network model.

(4) In the information processing method according to any one of (1) to (3) above, the second sensing data may include an image having a smaller blur than an image included in the first sensing data.

In this configuration, the second sensing data includes an image having a smaller blur than an image included in the first sensing data. The first neural network model having received the first operation parameter and the second sensing data can output, as the first sensing data, an image having a blur acquired by the operation of the first sensor using the first operation parameter.

(5) In the information processing method according to (4) above, the second sensor may be a camera including a lens, a diaphragm, and an imaging element.

This configuration enables the camera including the lens, the diaphragm, and the imaging element to acquire an image having a smaller blur than an image included in the first sensing data.

(6) In the information processing method according to (4) above, the second sensor may be a pinhole camera.

This configuration enables the pinhole camera to acquire an image with vignetting or a noise characteristic of an imaging element that is approximated to the vignetting or a noise characteristic of an imaging element in the multi-pinhole camera. The first neural network model having received the first operation parameter and the second sensing data including the image captured by the pinhole camera can output the first sensing data with a higher accuracy.

(7) In the information processing method according to any one of (1) to (6) above, the second sensing data may include images captured at different viewpoint positions.

This configuration enables the first neural network model to generate, from images captured at different viewpoint positions, the first sensing data including an image formed by superimposing the images captured at the different viewpoint positions.

(8) In the information processing method according to (7) above, the second sensing data may include images captured at a plurality of viewpoint positions.

This configuration enables the first neural network model to generate, from images captured at a plurality of viewpoint positions, the first sensing data including an image formed by superimposing the images captured at the viewpoint positions.

(9) In the information processing method according to (8) above, the first sensing data may include an image formed by superimposing a plurality of images acquired respectively through a plurality of pinholes, and the second sensing data may include an image captured at a viewpoint position corresponding to a position of each of the pinholes.

In this configuration, the second sensing data includes an image captured at a viewpoint position corresponding to a position of each of the pinholes. The second sensor thus can acquire depth information like the depth information acquired by the first sensor. Such use of the second sensor that can provide the depth information results in allowing the first neural network model to output the first sensing data with a higher accuracy.

Moreover, the disclosure can be realized as: the information processing method executing the above-described distinctive ways; and an information processing system including each distinctive feature corresponding to the distinctive ways executed by the information processing method. Additionally, the disclosure can be realized by a computer program causing a computer to execute the distinctive ways included in the information processing method. From these perspectives, the same advantageous effects as those of the information processing method are achievable in the following other aspects.

(10) An information processing system according to another aspect of the present disclosure includes: a first training part that trains a first neural network model so as to receive a first operation parameter for an operation of a first sensor and second sensing data obtained by an operation of a second sensor and output first sensing data obtained by the operation of the first sensor using the first operation parameter; a generation part that generates a third neural network model including the first neural network model and a second neural network model connected to each other in such a manner that the second neural network model receives the first sensing data output from the trained first neural network model and outputs an identification result of the first sensing data; a second training part that trains the second neural network model by backpropagation using an error difference between: the identification result which the third neural network model outputs after receiving the second sensing data and the first operation parameter; and correct identification information corresponding to the second sensing data; and an acquisition part that acquires a second operation parameter by updating the first operation parameter via the first neural network model by the backpropagation.

(11) An information processing program according to another aspect of the present disclosure includes: causing a computer to execute: training a first neural network model so as to receive a first operation parameter for an operation of a first sensor and second sensing data obtained by an operation of a second sensor and output first sensing data obtained by the operation of the first sensor using the first operation parameter; generating a third neural network model including the first neural network model and a second neural network model connected to each other in such a manner that the second neural network model receives the first sensing data output from the trained first neural network model and outputs an identification result of the first sensing data; training the second neural network model by backpropagation using an error difference between: the identification result which the third neural network model outputs after receiving the second sensing data and the first operation parameter; and correct identification information corresponding to the second sensing data; and acquiring a second operation parameter by updating the first operation parameter via the first neural network model by the backpropagation.

(12) A non-transitory computer readable medium according to still another aspect of the present disclosure stores an information processing program for causing a computer to execute, by the information processing program, processing including: training a first neural network model so as to receive a first operation parameter for an operation of a first sensor and second sensing data obtained by an operation of a second sensor and output first sensing data obtained by the operation of the first sensor using the first operation parameter; generating a third neural network model including the first neural network model and a second neural network model connected to each other in such a manner that the second neural network model receives the first sensing data output from the trained first neural network model and outputs an identification result of the first sensing data; training the second neural network model by backpropagation using an error difference between: the identification result which the third neural network model outputs after receiving the second sensing data and the first operation parameter; and correct identification information corresponding to the second sensing data; and acquiring a second operation parameter by updating the first operation parameter via the first neural network model by the backpropagation.

An embodiment of this disclosure will be described with reference to the accompanying drawings. It should be noted that the following embodiment illustrates one example of the disclosure, and does not delimit the technical scope of the disclosure.

### Embodiment

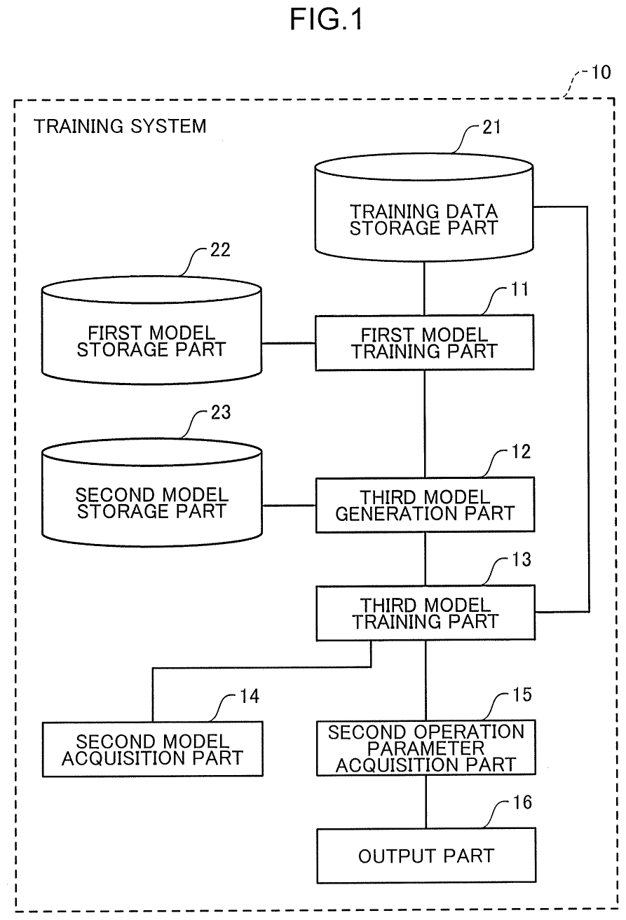

FIG. 1 is a block diagram showing a configuration of a training system 10 according an embodiment of the present disclosure.

The training system 10 includes, for example, a microprocessor, a Random Access Memory (RAM), a Read Only Memory (ROM), and a hard disk which are not specifically illustrated. The RAM, the ROM, or the hard disk stores a computer program, and the training system 10 comes into effect when the microprocessor operates in accordance with the computer program.

The training system 10 shown in FIG. 1 includes a first model training part 11, a third model generation part 12, a third model training part 13, a second model acquisition part 14, a second operation parameter acquisition part 15, an output part 16, a training data storage part 21, a first model storage part 22, and a second model storage part 23.

The training data storage part 21 stores data for use in training a first neural network model and a second neural network model. The training data storage part 21 stores a first operation parameter for an operation of a first sensor, second sensing data obtained by an operation of a second sensor, first sensing data obtained by the operation of the first sensor using the first operation parameter, and correct identification information corresponding to the second sensing data in association with one another. The correct identification information is also called annotation information.

In the embodiment, the first sensor is a lens-less multi-pinhole camera. The first operation parameter includes at least one of a focal distance of the lens-less multi-pinhole camera, the number of pinholes, a size of each of the pinholes, and a position of each of the pinholes. The second sensor is a typical camera including a lens, a diaphragm, and an imaging element. The second sensing data includes a second training image acquired by photographing by the typical camera. The second training image shows a subject being an identification target of the second neural network model. The first sensing data includes a first training image acquired by photographing by the lens-less multi-pinhole camera. The first sensing data includes an image formed by superimposing a plurality of images acquired respectively through a plurality of pinholes. The second sensing data includes an image having a smaller blur than an image included in the first sensing data. The first training image has a blur and the second training image has no blur. The first training image is an image obtained by photographing a scene which is the same as a scene shown in the second training image.

The first sensor may be another computational imaging camera, e.g., a lens-less camera, a coded aperture camera, or a light field camera. The first sensor acquires a blurred image by photographing. The first sensor in the embodiment is a lens-less multi-pinhole camera that includes a mask having a mask pattern with a plurality of pinholes and arranged to cover a light receiving surface of the imaging element. In other words, the mask pattern is located between the subject and the light receiving surface.

The first sensor acquires a computational photography having a blur unlike a typical camera that captures a normal image having no blur. The intentionally formed blur makes the subject seen in the computational photography unrecognizable even in viewing of the captured image itself by a person.

The second sensor may be, for example, a pinhole camera instead of the typical camera as long as the second sensor can acquire an image having a smaller blur than an image acquired by the first sensor. The correct identification information varies depending on an identification task. For instance, when the identification task indicates object detection, the correct identification information includes a bounding box defining a region occupied by a target to be detected on the image. Alternatively, for example, when the identification task indicates object identification, the correct identification information includes a classification result. Further alternatively, for example, when the identification task indicates segmentation of an image, the correct identification information includes regional information per pixel.

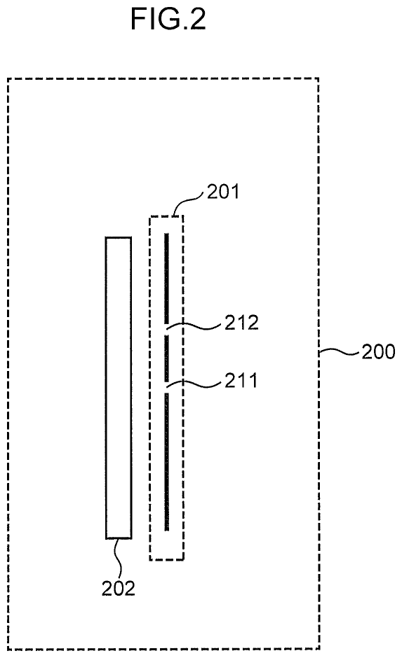

FIG. 2 is a schematic view of a structure of a lens-less multi-pinhole camera 200 serving as an example of the first sensor. FIG. 2 is a top view of the lens-less multi-pinhole camera 200.

The lens-less multi-pinhole camera 200 shown in FIG. 2 includes a multi-pinhole mask 201 and an image sensor 202, such as a CMOS image sensor. The multi-pinhole mask 201 is located at a predetermined distance from a light receiving surface of the image sensor 202. The lens-less multi-pinhole camera 200 has a focal distance agreeing with a distance between the multi-pinhole mask 201 and the image sensor 202. The multi-pinhole mask 201 has a plurality of pinholes 211, 212 located at random or at an equal interval. Each of the pinholes 211, 212 is called a multi-pinhole. The image sensor 202 acquires an image of a subject through each of the pinholes 211, 212. The image acquired through each of the pinholes is called a pinhole image.

The pinhole image of the subject differs depending on a position and a size of each of the pinholes 211, 212. Thus, the image sensor 202 acquires a superimposed image formed by superimposing multiple pinhole images overlapping each other while slightly shifting from each other. A positional relation between the pinholes 211, 212 has an influence on a positional relation (i.e., a superimposition degree of the multiple images) between the pinhole images projected onto the image sensor 202. The size of each of the pinholes 211, 212 has an influence on a blur degree of each pinhole image. The number of pinholes 211, 212 results in the number of superimposed pinhole images, and accordingly has an influence on the blur degree of the captured image.

Use of the multi-pinhole mask 201 enables acquisition of a plurality of pinhole images being superimposed and having different blur degrees at different positions. That is to say, a computational photography formed by multiple images to each intentionally have a blur is acquired. The captured image thus results in a blurred image formed by the multiple images. The associated blurs succeed in protecting the privacy of the subject shown in the image acquired in this manner.

Changing each of the number of pinholes, a position of each of the pinholes, and a size of each of the pinholes enables acquisition of images having different blur degrees. Specifically, the multi-pinhole mask 201 may be easily attachable and detachable by a user. Various kinds of multi-pinhole masks 201 having various mask patterns may be prepared in advance. The user may freely replace the multi-pinhole mask 201 to satisfy a mask pattern for a lens-less multi-pinhole camera to be used in image identification.

Various ways to be described below enable such a change of the multi-pinhole mask 201 in addition to the replacement or exchange of the multi-pinhole mask 201. For instance, the multi-pinhole mask 201 may be rotatably attached to the front of the image sensor 202 to be appropriately rotated by the user. Alternatively, for instance, the multi-pinhole mask 201 may have holes made by the user at appropriate portions of a plate attached to the front of the image sensor 202. Further alternatively, for instance, the multi-pinhole mask 201 may be a liquid crystal mask using a spatial light modulator. The multi-pinhole mask 201 may have a predetermined number of pinholes respectively at predetermined positions therein in accordance with an appropriately set transmittance at each of the positions. For instance, the multi-pinhole mask 201 may be made of rubber or other stretchable material. The user may physically deform the multi-pinhole mask 201 by applying an external force thereto to change the position and the size of each pinhole.

Specifically, a large change may be seen in a captured image due to each of the focal distance of the lens-less multi-pinhole camera 200, the number of pinholes, the size of each of the pinholes, and the position of each of the pinholes, each included in the first operation parameter. It is thus necessary to determine an optimal operation parameter. The training system 10 in the embodiment optimizes the first operation parameter to improve an identification result from the second neural network model. The optimization leads to improvement in the identification result from the second neural network model.

Although FIG. 2 shows the two pinholes 211, 212 horizontally aligning, this disclosure is not particularly limited to the arrangement. The lens-less multi-pinhole camera 200 may include three or more pinholes. The two pinholes 211, 212 may vertically align.

The first model storage part 22 stores the first neural network model. The first neural network model includes a device simulator that simulates the first sensor. The first neural network model receives the first operation parameter and the second sensing data, and the first neural network model outputs the first sensing data obtained from the second sensing data by an operation of the first sensor using the first operation parameter.

The second model storage part 23 stores the second neural network model. The second neural network model receives the first sensing data or an output from the first neural network model, and the second neural network model outputs an identification result.

The first model training part 11 acquires the first neural network model from the first model storage part 22. The first model training part 11 acquires the first sensing data, the first operation parameter, and the second sensing data from the training data storage part 21.

The first model training part 11 trains the first neural network model so as to receive the first operation parameter for the operation of the first sensor and the second sensing data obtained by the operation of the second sensor and output the first sensing data obtained by the operation of the first sensor using the first operation parameter.

The third model generation part 12 acquires the second neural network model from the second model storage part 23. The third model generation part 12 generates the third neural network model including the first neural network model and the second neural network model connected to each other in such a manner that the second neural network model receives the first sensing data output from the trained first neural network model and outputs an identification result of the first sensing data.

The third model training part 13 trains the second neural network model by backpropagation using an error difference between: the identification result which the third neural network model outputs after receiving the second sensing data and the first operation parameter; and correct identification information corresponding to the second sensing data.

The second model acquisition part 14 acquires the second neural network model trained by the third model training part 13.

The second operation parameter acquisition part 15 acquires a second operation parameter by updating the first operation parameter via the first neural network model by the backpropagation.

The output part 16 outputs the second operation parameter acquired by the second operation parameter acquisition part 15.

Subsequently, a training process by the training system 10 according to the embodiment of this disclosure will be described.

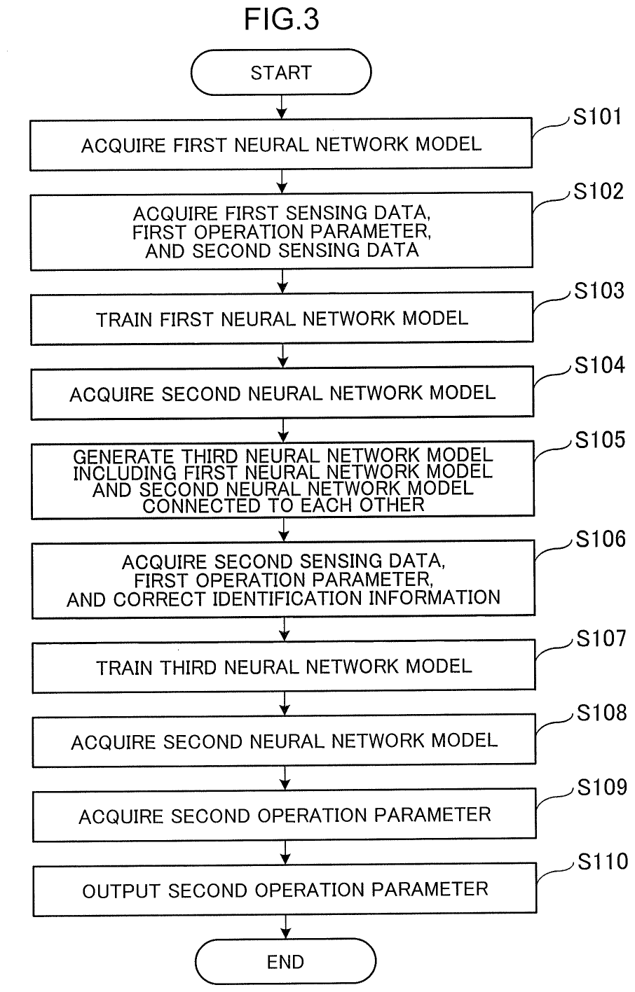

FIG. 3 is a flowchart explaining the training process by the training system 10 according to the embodiment of the disclosure.

First, the first model training part 11 acquires the first neural network model from the first model storage part 22 (step S101).

Next, the first model training part 11 acquires the first sensing data, the first operation parameter, and the second sensing data from the training data storage part 21, the data and the parameter being necessary for training the first neural network model (step S102). Specifically, the first model training part 11 acquires the first training image captured by a lens-less multi-pinhole camera serving as the first sensor, the first operation parameter of the lens-less multi-pinhole camera used in capturing the first training image, and the second training image captured by photographing a scene, which is the same as a scene shown in the first training image, by a typical camera serving as the second sensor. The first operation parameter includes a focal distance of the lens-less multi-pinhole camera, the number of pinholes, a size of each of the pinholes, and a position of each of the pinholes.

Subsequently, the first model training part 11 trains the first neural network model by using the first sensing data, the first operation parameter, and the second sensing data acquired from the training data storage part 21 (step S103). The first model training part 11 trains the first neural network model so as to receive the first operation parameter and the second sensing data and output the first sensing data by defining the first operation parameter and the second sensing data acquired from the training data storage part 21 as input data and defining the first sensing data acquired from the training data storage part 21 as Ground Truth (GT) data. The first model training part 11 trains the first neural network model by, for example, the backpropagation (BackPropagation) which is one of algorithms for deep learning.

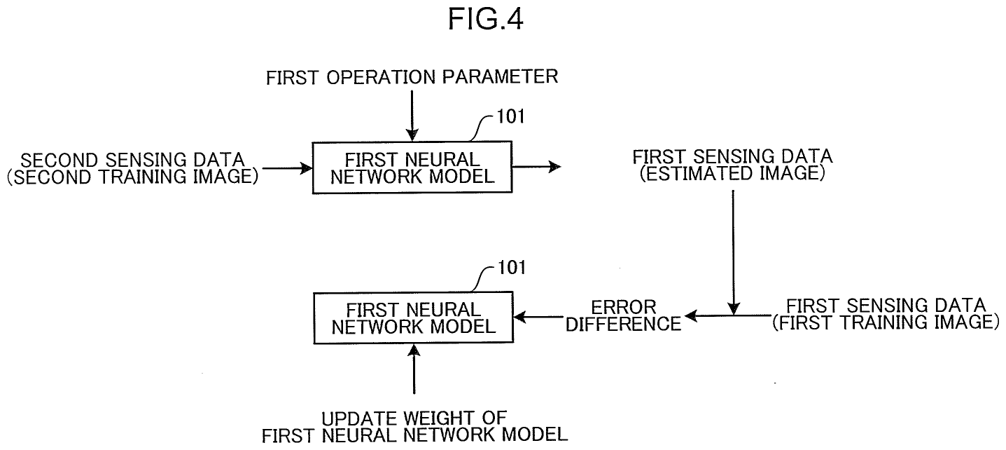

FIG. 4 is a schematic view explaining training of the first neural network model in the embodiment.

The first model training part 11 gives, to a first neural network model 101, input data including: a focal distance of the lens-less multi-pinhole camera, the number of pinholes, a size of each of the pinholes, and a position of each of the pinholes, each included in first operation parameter; and the second training image captured by a typical camera and included in the second sensing data. The first model training part 11 acquires, from the first neural network model 101, output data including an estimated image obtained by virtually photographing a scene, which is the same as a scene shown in the second training image, by the lens-less multi-pinhole camera designed with the first operation parameter. The first model training part 11 updates a weight of the first neural network model to attain a minimum error difference between the estimated image output from the first neural network model 101 and the first training image acquired by actually photographing the same scene as the scene shown in the second training image by the lens-less multi-pinhole camera designed with the first operation parameter.

The first model training part 11 may use, for example, the Conditional GAN or the Conditional Filtered GAN as a training way for generating an output image with an attribute of the first operation parameter to train the first neural network model by defining the first operation parameter as a multi-dimensional latent variable. The Conditional GAN is disclosed in the existing literature, Mehdi Mirza and Simon Osindero, “Conditional Generative Adversarial Nets”, arXiv preprint arXiv preprint arXv: 1411. 1784, 2014. The Conditional Filtered GAN is disclosed in the existing literature, Takuhiro Kaneko, Kaoru Hiramatsu, and Kunio Kashino, “Generative Attribute Controller with Conditional Filtered Generative Adversarial Networks”, Proceedings of the IEEE Conference on Computer Vision and Pattern Recognition, pp. 6089-6098, 2017.

Such training of the first neural network model allows the first neural network model to receive the first operation parameter and the second sensing data and output an estimated image acquired by photographing a scene by the lens-less multi-pinhole camera with the first operation parameter, the scene being the same as the scene shown in the image captured by the typical camera and included in the second sensing data.

The first model training part 11 may output the trained first neural network model to the first model storage part 22 and store the trained first neural network model in the first model storage part 22. The first model training part 11 may update the first neural network model stored in the first model storage part 22 to the trained first neural network model.

Referring back to FIG. 3, subsequently, the third model generation part 12 acquires the second neural network model from the second model storage part 23 (step S104).

The third model generation part 12 then generates the third neural network model including the first neural network model and the second neural network model connected to each other in such a manner that the second neural network model acquired from the second model storage part 23 receives the output from the first neural network model trained by the first model training part 11 (step S105).

Further, the third model training part 13 acquires the second sensing data, the first operation parameter, and the correct identification information corresponding to the second sensing data from the training data storage part 21, the data, the parameter, and the information being necessary for training of the third neural network model (step S106). Specifically, the third model training part 13 acquires the second training image captured by the typical camera serving as the second sensor, the first operation parameter of the lens-less multi-pinhole camera serving as the first sensor, and correct identification information corresponding to the second training image. The first operation parameter includes a focal distance of the lens-less multi-pinhole camera, the number of pinholes, a size of each of the pinholes, and a position of each of the pinholes.

Next, the third model training part 13 trains the third neural network model by using the second sensing data, the first operation parameter, and the correct identification information acquired from the training data storage part 21 (step S107). The third model training part 13 inputs the first operation parameter and the second sensing data acquired from the training data storage part 21 into the first neural network model, defines the first sensing data output from the first neural network model as input data for the second neural network model and defines the correct identification information corresponding to the second sensing data as annotation data of the second neural network model, and trains the second neural network model so as to output an identification result after the first neural network model receives the first operation parameter and the second sensing data. The third model training part 13 trains the third neural network model by, for example, the backpropagation (BackPropagation) which is one of algorithms for deep learning.

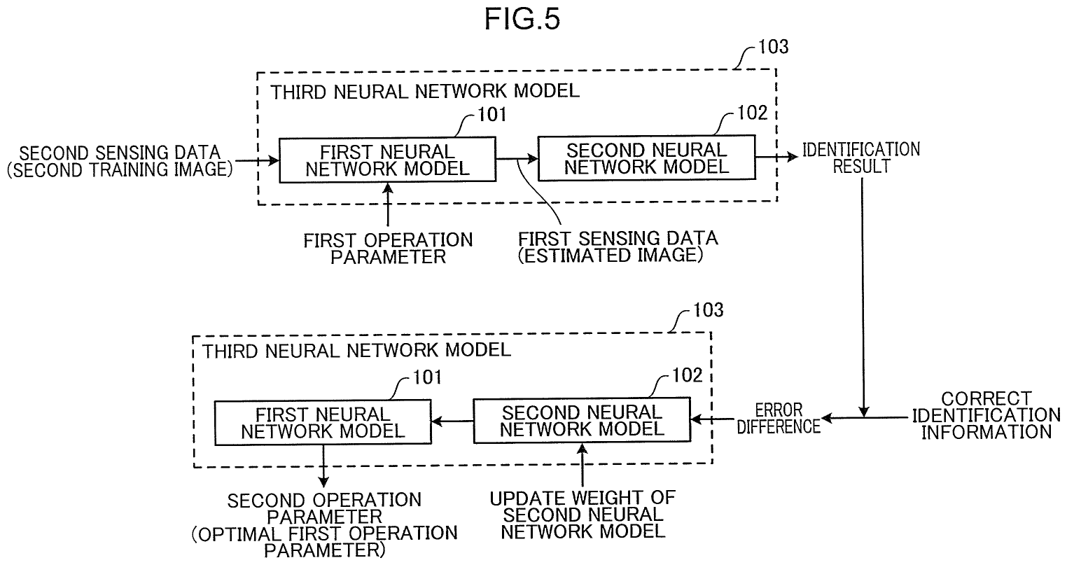

FIG. 5 is a schematic view explaining training of the third neural network model in the embodiment.

The third model training part 13 gives, to the first neural network model 101 included in a third neural network model 103, input data including: a focal distance of the lens-less multi-pinhole camera, the number of pinholes, a size of each of the pinholes, and a position of each of the pinholes, each included in the first operation parameter; and a second training image captured by the typical camera and included in the second sensing data. The third model training part 13 acquires, from the first neural network model 101, output data including an estimated image acquired by virtually photographing a scene, which is the same as a scene shown in the second training image, by the lens-less multi-pinhole camera designed with the first operation parameter.

The third model training part 13 gives, to a second neural network model 102 included in the third neural network model 103, input data including the estimated image output from the first neural network model 101. The third model training part 13 updates the weight of the second neural network model 102 to attain a minimum error difference between an identification result output from the second neural network model 102 and correct identification information corresponding to the second training image. Further, the third model training part 13 acquires the second operation parameter by updating the first operation parameter via the first neural network model 101 by backpropagation to attain a minimum error difference between the identification result output from the second neural network model 102 and the correct identification information corresponding to the second training image. The second operation parameter indicates the optimal first operation parameter. The third model training part 13 updates only the first operation parameter being a multi-dimensional latent variable without updating the weight of the trained first neural network model 101, and acquires the updated multi-dimensional latent variable as the second operation parameter.

Any network model is usable for the second neural network model depending on each identification task. The second neural network model may adopt, for example, the CenterNet or the YOLOv4. The CenterNet is disclosed in the existing literature, Xingyi Zhou, Dequan Wang, and Philipp Krahenbuhl, “Objects as Points”, arXiv: 1904.07850, 2019. The YOLOv4 is disclosed in the existing literature, Alexy Bochkovskiy, Chien-Yao Wang, and Hong-Yuan Mark Liao, “YOLOv4: Optimal Speed and Accuracy of Object Detection”, arXiv: 2004.10934, 2020.

The third model training part 13 trains only the second neural network model without training the first neural network model when training the third neural network model. In other words, only the weight information about the second neural network model is updated by the backpropagation.

Referring back to FIG. 3, next, the second model acquisition part 14 acquires the second neural network model from the third neural network model trained by the third model training part 13 (step S108). The second model acquisition part 14 determines the weight of the acquired second neural network model as the weight of the second neural network model.

The second model acquisition part 14 may output the acquired second neural network model to the second model storage part 23 and store the acquired second neural network model in the second model storage part 23. The second model acquisition part 14 may update the second neural network model stored in the second model storage part 23 to the trained second neural network model. The second model acquisition part 14 may send the second neural network model to an external computer.

Subsequently, in the training by the third model training part 13, the second operation parameter acquisition part 15 acquires, as the second operation parameter, a multi-dimensional latent variable corresponding to the first operation parameter of the first neural network model calculated by the backpropagation (step S109).

The output part 16 then outputs the second operation parameter acquired by the second operation parameter acquisition part 15 (step S110). The output part 16 may output the second operation parameter to an internal memory in the training system 10 so that the second operation parameter is stored in the memory, or may send the second operation parameter to the external computer.

The second operation parameter acquisition part 15 determines the acquired second operation parameter as the optimal first operation parameter. The second operation parameter is an operation parameter of the first sensor that is optimal for identification of the second neural network model. The first sensor or lens-less multi-pinhole camera is designed with the second operation parameter acquired by the second operation parameter acquisition part 15. The second neural network model acquired by the second model acquisition part 14 performs identification of the first sensing data or a captured image acquired by the designed first sensor or lens-less multi-pinhole camera.

The training system 10 in the embodiment enables determination of the second neural network model for each identification task and further determination of the optimal first operation parameter through training for the identification by the second neural network model, and thus achieves the training for each identification task with a higher accuracy.

In the embodiment, the third model training part 13 may acquire, from the training data storage part 21, the first sensing data including the first training image and the correct identification information corresponding to the second training image captured by the typical camera serving as the second sensor without acquiring the first operation parameter and the second sensing data. In this case, the third model training part 13 may train the second neural network model included in the third neural network model in such a manner that the second neural network model receives the first sensing data and outputs the correct identification information.

Next, the data stored in the training data storage part 21 and the first operation parameter of the first sensor will be described.

As described above, the first sensor is, for example, a lens-less multi-pinhole camera. The lens-less multi-pinhole camera here includes at least two positions as positions for a plurality of pinholes among nine pinhole positions. The number of pinholes is hence defined as two or more to nine or less. In other words, the first operation parameter includes the number of pinholes and a position of each of the pinholes.

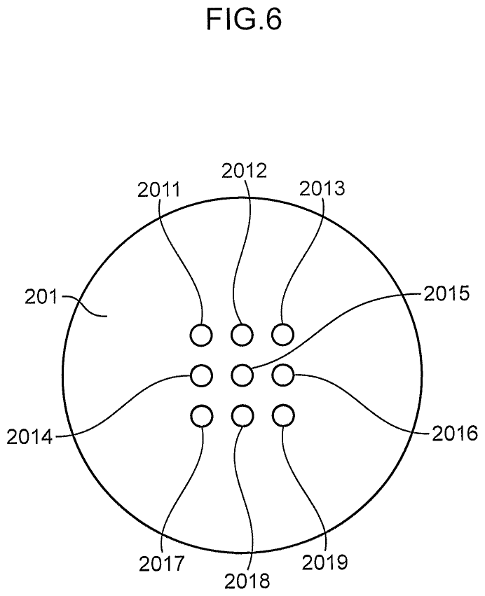

FIG. 6 is a schematic view showing an example of the multi-pinhole mask 201 having a plurality of pinholes.

The multi-pinhole mask 201 has at least two pinholes at corresponding two positions among nine pinhole positions 2011 to 2019 arrayed in a matrix of 3×3. The positions of pinholes included in the first operation parameter represent at least two positions among the nine pinhole positions 2011 to 2019.

The training data storage part 21 stores, as the first sensing data, the first training image captured by the lens-less multi-pinhole camera which serves as the first sensor and is provided with a pinhole at least at corresponding two positions among the nine pinhole positions 2011 to 2019.

The training data storage part 21 further stores, as the first operation parameter, information indicating a specific position where a pinhole is formed in the lens-less multi-pinhole camera having captured the image included in the first sensing data among the nine pinhole positions 2011 to 2019.

The training data storage part 21 stores, as the second sensing data, the second training image captured by photographing a scene, which is the same as a scene shown in the first sensing data, by the typical camera.

The training data storage part 21 further stores correct identification information corresponding to the second training image captured by the typical camera and included in the second sensing data.

The first model training part 11 trains the first neural network model by using the Conditional GAN so as to receive: the first operation parameter being a multi-dimensional latent variable and defining “1” for a position where a pinhole is and “0” for a position where no pinhole is among the nine pinhole positions; and the second sensing data, and output the first sensing data.

The third model training part 13 uses the Center Net or other way for the second neural network model, and further trains the third neural network so as to output the correct identification information corresponding to the second training image captured by the typical camera serving as the second sensor after the second neural network model receives, as input data, estimated data of the first sensing data which is obtained by the operation of the first sensor using the first operation parameter and is output from the first neural network model after the first neural network model receives the first operation parameter of the first sensor and the second sensing data of the second sensor.

Data stored in the training data storage part 21 is not limited to the above-described data. For instance, the second sensor may be a pinhole camera or a lens-less pinhole camera, and the second sensing data may include image data captured by the pinhole camera or the lens-less pinhole camera. This means, for example, use of an image captured by a lens-less pinhole camera that includes the multi-pinhole mask 201 shown in FIG. 6 and having a pinhole only at the center pinhole position 2015 of the mask. The lens-less pinhole camera having this configuration can acquire an image with vignetting or a noise characteristic of an image sensor that is approximated to the vignetting or a noise characteristic of an imaging element in the lens-less multi-pinhole camera. The first neural network model having received the first operation parameter and the second sensing data acquired by photographing by the pinhole camera or the lens-less pinhole camera can output the first sensing data with a higher accuracy.

The second sensing data may include images captured at different viewpoint positions. The second sensing data may include images captured at a plurality of viewpoint positions. For instance, the second sensing data may include images captured at a plurality of viewpoint positions having a positional relation similar to the positional relation among the nine pinhole positions intended for the lens-less multi-pinhole camera.

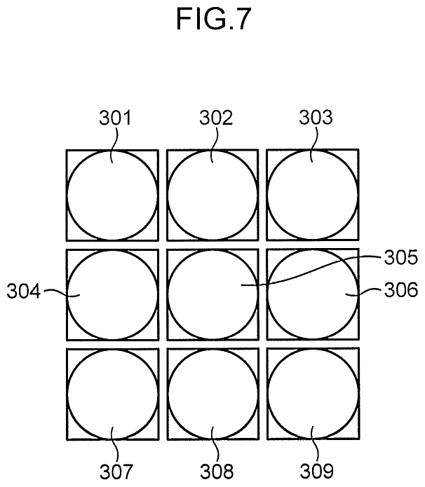

FIG. 7 is a schematic view showing an example of the second sensor that captures images respectively from a plurality of viewpoint positions.

In FIG. 7, the second sensor is a nine stereo camera including nine typical cameras 301 to 309 arrayed in a matrix of 3×3.

In FIG. 6, the pinhole position 2015 is at the center of the multi-pinhole mask 201. The pinhole position 2011 is to the upper-left of the pinhole position 2015. The pinhole position 2012 is above the pinhole position 2015. The pinhole position 2013 is to the upper-right of the pinhole position 2015. The pinhole position 2014 is to the left of the pinhole position 2015. The pinhole position 2016 is to the right of the pinhole position 2015. The pinhole position 2017 is to the lower-left of the pinhole position 2015. The pinhole position 2018 is under the pinhole position 2015. The pinhole position 2019 is to the lower-right of the pinhole position 2015.

The typical cameras 301 to 309 constituting the nine stereo camera serving as the second sensor shown in FIG. 7 are arranged to respectively come to the pinhole positions of the multi-pinhole mask 201.

In other words, the typical camera 305 is at the center of the stereo camera. The typical camera 301 is to the upper-left of the typical camera 305. The typical camera 302 is above the typical camera 305. The typical camera 303 is to the upper-right of the typical camera 305. The typical camera 304 is to the left of the typical camera 305. The typical camera 306 is to the right of the typical camera 305. The typical camera 307 is to the lower-left of the typical camera 305. The typical camera 308 is under the typical camera 305. The typical camera 309 is to the lower-right of the typical camera 305.

The lens-less multi-pinhole camera captures an image by superimposing images at a plurality of viewpoint positions. The captured image thus includes depth information about a subject indicating a parallax difference between viewpoints, such depth information being not included in an image captured by a typical camera. The second sensor shown in FIG. 7 includes the typical cameras 301 to 309 arranged to come to the pinhole positions 2011 to 2019 of the multi-pinhole mask 201 which is shown in FIG. 6 and is included in the lens-less multi-pinhole camera. The second sensing data includes an image captured at a viewpoint position corresponding to a position of each of the pinholes. The second sensor thus can acquire depth information like the depth information acquired by the first sensor. Such use of the second sensor that can provide the depth information results in allowing the first neural network model to output the first sensing data with a higher accuracy.

In a case where the second sensing data includes images captured at a plurality of viewpoint positions, the number of viewpoint positions does not necessarily agree with the number of pinhole positions intended for the multi-pinhole camera. The number of viewpoint positions of the second sensor may be smaller or larger than the number of pinhole positions. The smaller number of viewpoint positions of the second sensor leads to the smaller number of data pieces, resulting in achieving cost saving. Alternatively, the larger number of viewpoint positions of the second sensor allows the first neural network model to output the first sensing data with a much higher accuracy. In the case where the second sensing data includes images captured at a plurality of viewpoint positions, the correct identification information may be for an image captured at one of the viewpoint positions or may be for images respectively captured at the viewpoint positions.

The second sensing data is not limited to two-dimensional image data and may include three-dimensional image data having depth information. Examples of the three-dimensional image data include point cloud data.

In a case where the first operation parameter includes information indicating a size of each of the pinholes, the first model training part 11 uses the Conditional Filtered GAN for the first neural network model. In this case, the first model training part 11 may train the first neural network model so as to receive the first operation parameter as a multi-dimensional latent variable and the second sensing data and output the first sensing data, the first operation parameter defining a size at a pinhole position where no pinhole is made as “0” and defining a size of a pinhole made at an associated pinhole position to be larger as a diameter of the pinhole increases among nine pinhole positions.

In a case where the first operation parameter includes information indicating a focal distance of the lens-less multi-pinhole camera, the first model training part 11 uses the Conditional Filtered GAN for the first neural network model. In this case, the first model training part 11 may train the first neural network model so as to receive: a normalized focal distance, as a latent variable, obtained by normalizing the focal distance included in the first operation parameter to 0 or more to 1 or less; and the second sensing data, and output the first sensing data.

Such a pinhole position as included in the first operation parameter may indicate a coordinate value on the multi-pinhole mask 201 without limitation to the preset value as described above. In this case, the first model training part 11 uses the Conditional Filtered GAN for the first neural network model. The first model training part 11 trains the first neural network model so as to receive: a normalized coordinate value, as a multi-dimensional latent variable, obtained by normalizing the coordinate value on the two-dimensional coordinate (u, v) on the multi-pinhole mask 201 to 0 or more to 1 or less; and the second sensing data, and output the first sensing data.

The third model training part 13 in the embodiment estimates the first sensing data which is not stored in the training data storage part 21 by inputting the first operation parameter and the second sensing data into the trained first neural network model. In this case, the third model training part 13 may use correct identification information corresponding to the second sensing data regardless of the first operation parameter. Such usage enables training of the second neural network model for the first sensing data which is not stored in the training data storage part 21 while reducing the cost, which is to be an issue in the training, for addition of the correct identification information. This achieves training of the third neural network model using more training data and attains estimation with a higher accuracy.

The third model training part 13 may use the first sensing data as input data for the second neural network model in place of using the output from the first neural network model. When the training data storage part 21 stores a sufficient amount of the first sensing data for the training, the third model training part 13 can train the third neural network model without using a result of the estimation by the first neural network model. It is noted here that the first neural network model is trained in step S103 in this case as well. This is because the trained first neural network model is required to acquire the second operation parameter as described later.

Although use of the lens-less multi-pinhole camera serving as the first sensor is described heretofore, the first sensor may be another sensor. For instance, the first sensor may be a coded aperture (Coded Aperture) camera having a lens.

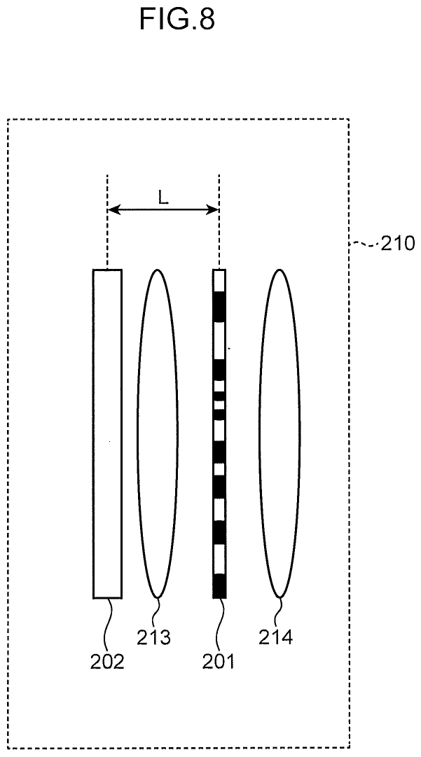

FIG. 8 is a schematic view of a structure of a coded aperture camera 210 serving as another example of the first sensor.

The coded aperture camera 210 shown in FIG. 8 includes a multi-pinhole mask 201, an image sensor 202, such as a CMOS image sensor, and a plurality of lenses 213, 214. The number of lenses is not necessarily limited to two, and may be any other numbers. The multi-pinhole mask 201 is disposed between the image sensor 202 and a subject. In this case, the first operation parameter includes at least one of a distance L (shown in FIG. 8) between the multi-pinhole mask 201 and the image sensor 202, the number of pinholes, a size of each of the pinholes, and a position of each of the pinholes.

The multi-pinhole mask 201 in the coded aperture camera 210 is called an encoded mask as well and corresponds to diaphragm. Thus, the Point Spread Function (PSF) showing a blur degree of the coded aperture camera 210 depends on the multi-pinhole mask 201. For instance, in a configuration in which the multi-pinhole mask 201 has two pinholes, an image captured by the coded aperture camera 210 results in a superimposed image formed by superimposing two images (multiple images) respectively showing subjects overlapping while shifting from each other except their focal positions. Specifically, a positional relation between the pinholes has an influence on a positional relation (i.e., a superimposition degree of the multiple images) between the images projected onto the image sensor 202. A size of each of the pinholes results in the size of diaphragm, and accordingly has an influence on a blur degree of each image. The number of pinholes results in the number of superimposed images, and accordingly has an influence on the blur degree of the captured image.

Photographing a subject seen in displacement from the focus position by the coded aperture camera 210 using the multi-pinhole mask 201 enables acquisition of an image formed by superimposing images having different blur degrees at different positions. That is to say, a computational photography formed by multiple images to each intentionally have a blur is acquired. The captured image thus results in a blurred image formed by the multiple images. The associated blurs succeed in protecting the privacy of the subject shown in the image acquired in this manner.

A large change may be seen in the captured image due to each of the distance L between the multi-pinhole mask 201 and the image sensor 202, the number of pinholes, the size of each of the pinholes, and the position of each of the pinholes, each included in the first operation parameter. It is thus necessary to determine an optimal operation parameter. The training system 10 in the embodiment optimizes the first operation parameter to improve an identification result from the second neural network model. The optimization leads to improvement in the identification result from the second neural network model.

The third model training part 13 in the embodiment enables estimation of the first sensing data which is not stored in the training data storage part 21 by inputting the first operation parameter and the second sensing data into the trained first neural network model, and training of the third neural network model by using the estimated first sensing data. This achieves training of the third neural network model using more training data and attains estimation with a higher accuracy.

In the embodiment, each constituent element may be realized with dedicated hardware or by executing a software program suitable for the constituent element. Each constituent element may be realized by a program execution unit, such as a CPU or a processor, reading out and executing a software program recorded on a recording medium, such as a hard disk or a semiconductor memory. Other independent computer system may implement a program by recording the program in a recording medium to be transferred, or transferring the program via a network.

A part of or a whole of the functions of the device according to the embodiment of the disclosure are typically realized as a large scale integration (LSI), which is an integrated circuit. These functions may be formed as separate chips, or some of or a whole of the functions may be included in one chip. The circuit integration is not limited to the LSI, and may be realized with a dedicated circuit or a general-purpose processor. A field programmable gate array (FPGA) that is programmable after manufacturing of an LSI or a reconfigurable processor in which connections and settings of circuit cells within the LSI are reconfigurable may be used.

A part of or a whole of the functions of the device according to the embodiment of the present disclosure may be implemented by a processor, such as a CPU executing a program.

Numerical values used above are merely illustrative to be used to specifically describe the present disclosure, and thus the present disclosure is not limited to the illustrative numerical values.

Order in which steps shown in the flowcharts are executed is merely illustrative to be used to specifically describe the present disclosure, and thus steps may be executed in order other than the above order as long as similar effects are obtained. Some of the steps may be executed simultaneously (in parallel) with other steps.

The technology in the present disclosure achieves optimization of an operation parameter of a sensor serving as an input device for a neural network model and improvement in an identification accuracy of the neural network model. The technology is hence useful for generating an identification model through machine learning and optimizing the operation parameter for the sensor to obtain sensing data to be input into the identification model.

1. An information processing method comprising:
by a computer,
training a first neural network model so as to receive a first operation parameter for an operation of a first sensor and second sensing data obtained by an operation of a second sensor and output first sensing data obtained by the operation of the first sensor using the first operation parameter;
generating a third neural network model including the first neural network model and a second neural network model connected to each other in such a manner that the second neural network model receives the first sensing data output from the trained first neural network model and outputs an identification result of the first sensing data;
training the second neural network model by backpropagation using an error difference between: the identification result which the third neural network model outputs after receiving the second sensing data and the first operation parameter; and correct identification information corresponding to the second sensing data; and
acquiring a second operation parameter by updating the first operation parameter via the first neural network model by the backpropagation.

2. The information processing method according to claim 1, wherein the first sensor is a coded aperture camera, and
the first operation parameter includes at least one of a distance between an encoded mask and an image sensor, the number of pinholes, a size of each of the pinholes, and a position of each of the pinholes.

3. The information processing method according to claim 1, wherein the first sensor is a lens-less multi-pinhole camera, and
the first operation parameter includes at least one of a focal distance of the lens-less multi-pinhole camera, the number of pinholes, a size of each of the pinholes, and a position of each of the pinholes.

4. The information processing method according to claim 1, wherein the second sensing data includes an image having a smaller blur than an image included in the first sensing data.

5. The information processing method according to claim 4, wherein the second sensor is a camera including a lens, a diaphragm, and an imaging element.

6. The information processing method according to claim 4, wherein the second sensor is a pinhole camera.

7. The information processing method according to claim 1, wherein the second sensing data includes images captured at different viewpoint positions.

8. The information processing method according to claim 7, wherein the second sensing data includes images captured at a plurality of viewpoint positions.

9. The information processing method according to claim 8, wherein the first sensing data includes an image formed by superimposing a plurality of images acquired respectively through a plurality of pinholes, and
the second sensing data includes an image captured at a viewpoint position corresponding to a position of each of the pinholes.

10. An information processing system, comprising:
a first training part that trains a first neural network model so as to receive a first operation parameter for an operation of a first sensor and second sensing data obtained by an operation of a second sensor and output first sensing data obtained by the operation of the first sensor using the first operation parameter;
a generation part that generates a third neural network model including the first neural network model and a second neural network model connected to each other in such a manner that the second neural network model receives the first sensing data output from the trained first neural network model and outputs an identification result of the first sensing data;
a second training part that trains the second neural network model by backpropagation using an error difference between: the identification result which the third neural network model outputs after receiving the second sensing data and the first operation parameter; and correct identification information corresponding to the second sensing data; and
an acquisition part that acquires a second operation parameter by updating the first operation parameter via the first neural network model by the backpropagation.

11. A non-transitory computer-readable storage medium that stores an information processing program for causing a computer to execute, by the information processing program, processing comprising:
training a first neural network model so as to receive a first operation parameter for an operation of a first sensor and second sensing data obtained by an operation of a second sensor and output first sensing data obtained by the operation of the first sensor using the first operation parameter;
generating a third neural network model including the first neural network model and a second neural network model connected to each other in such a manner that the second neural network model receives the first sensing data output from the trained first neural network model and outputs an identification result of the first sensing data;
training the second neural network model by backpropagation using an error difference between: the identification result which the third neural network model outputs after receiving the second sensing data and the first operation parameter; and correct identification information corresponding to the second sensing data; and
acquiring a second operation parameter by updating the first operation parameter via the first neural network model by the backpropagation.
